(19) United States
(12) Patent Application Publication
(10) Pub. No.: US 2016/0364996 A1
(43) Pub. Date: Dec. 15, 2016

(54) MATCHING LEARNING CONTENT TO LEARNERS

(71) Applicant: Learning Threads Corporation, San Diego, CA (US)

(72) Inventor: Trevor Gile, San Diego, CA (US)

(73) Assignee: Learning Threads Corporation, San Diego, CA (US)

(21) Appl. No.: 14/734,922

(22) Filed: Jun. 9, 2015

(51) Int. Cl. G09B 7/00; G09B 5/06

(52) U.S. Cl. CPC G09B 7/00; G09B 5/06

(57) ABSTRACT

Providing relationships between items of learning content, where the items of learning content and/or identity of items of learning content are available over a network. Learning content information can be generated that describe characteristics of the items of learning content by parsing the learning content. Relationship information can be received that describe relationships between items of learning content. A relationship graph can be generated that contains the relationships. Learner information can be received that contains characteristics of learners. The characteristics of the learners can facilitate generation of learner metrics based on statistical analysis of the learner characteristics. The learner metrics can facilitate matching of items of learning content to the learners.

### TECHNICAL FIELD

The subject matter described herein relates to matching learning content to learners.

### BACKGROUND

A vast amount of learning content is available for learners. A large amount of this learning content has become available online. Some example online learning content providers and platforms include Wikipedia, Coursera, Udemy, YouTube, Lynda, Udacity, Code Academy, IEEE, Stack Overflow, and Khan Academy. Learning content providers range from small providers to large providers. Some providers are topic-specific, whereas other providers offer a wide array of learning content across different subject matter. In addition to online content, traditional resources (e.g. books, textbooks, seminars, workshops, etc. . . . ) remain an important source of learning content.

Typically, those interested in finding learning content (existing both online and offline) turn to search services, such as online search engines. Current search engines are inherently limited in their ability to provide meaningful search results to the learner's keyword query.

### SUMMARY

In one aspect, a method is described for implementation by one or more data processors forming part of at least one computing device. The method provides relationships between items of learning content. Learning content can include one or more of video, photographic, audio, text, digital, multi-media, and/or other learning content. Indications of one or more items of learning content can be received at the one or more data processors. The one or more data processors can generate one or more sets of learning content information to associate with the one or more items of learning content. In some variations, learning content information can be generated based on input received from one or more users associated with a subject matter of the one or more items of learning content. The learning content information can reflect one or more of a subject matter, a mode of delivery, a quality, a difficulty, a cost or a type of learning content of the one or more items of learning content. The learning content information can be automatically generated based on the content of the items of learning content. The one or more items of learning content can be parsed. Estimated characteristics can be generate for each of the one or more items of learning content based on the information obtained from parsing the one or more items of learning content. The one or more sets of learning content information can be generated and/or updated based on the estimated characteristics for the one or more items of learning content.

Relationship information between individual ones of the one or more items of learning content from one or more users can be received. Relationship information can define connections between individual ones of the one or more items of learning content. A relationship graph can be generated. The relationship graph can include the relationship information between individual ones of the one or more items of learning content. The relationship graph can be stored in a database in non-transitory machine readable media.

Users can provide a rating of the relationship information between individual ones of the one or more items of learning content. The one or more sets of learning content information can be updated based on the rating. The one or more relationship graphs can be generated for individual ones of the users. One or more items of learning content can be selected to be included in the one or more relationship graphs for the individual users based on the rating received from the individual users. Users can provide a graph rating of the relationship graph. The graph rating can be provided through a graphical user interface. The relationship graph can be updated based on the graph rating provided by the users.

At least one learning metric can be generated that is associated with individual ones of the one or more items of learning content. The at least one learning metric can be based on the one or more sets of learning content information. The one or more sets of learning content information can include tags. The tags can reflect the characteristics of the one or more items of learning content associated with the one or more sets of learning content information.

In one aspect, a method for implementation by one or more data processors forming part of at least one computing device to match content learners with learning content is described. Learner information can be determined. The learner information can include one or more characteristics of a learner. The learner information can be obtained automatically by obtaining publically accessible information. The learner information can be obtained from one or more proprietary information resources. The learner information can be provided by the learner by the learner providing the information through a graphical user interface. In some variations, determining one or more learning characteristics of the learner can include statistically inferring the learning characteristics of the learner. In some variations, determining one or more learning characteristics can include receiving assessment information of the capabilities of the learner from one or more of the learner, an assessor of the learner, and/or other source.

A relationship graph can be accessed. The relationship graph can define relationships between one or more items of learning content. The one or more items of learning content can have associated learning content information characterizing the learning content.

One or more items of learning content can be matched to the learner. The matching can be based on the one or more characteristics of the learner, the learning content information, the relationships between the one or more items of learning content and/or other information.

A learner metric can be generated that is associated with the learner. The learner metric can be based on the one or more characteristics of the learner. At least one learning content metric can be generated. The at least one learning content metric can be associated with the one or more items of learning content. The at least one learning content metric can be based on the learning content information associated with the one or more items of learning content.

The learner metric can be assigned to at least one tag associated with the learner. The learning content metric can be associated with at least one tag associated with the at least one learning content.

A curriculum can be generated for the learner. The curriculum can be based on the one or more characteristics of the learner, the learning content information associated with the one or more items of learning content, the relationships between the one or more items of learning content, and/or other information. The curriculum can include a plurality of items of learning content.

A request for learning content can be received from a learner. The relationship graph can be searched to identify one or more items of learning content matching the request for learning content from the learner. At least an indication of the learning content can be matched to the learner's request.

Software applications configured to facilitate the implementation of the currently described methods are contemplated by this disclosure. Such software applications can be implemented on processors. The processors can implement such software applications with the aid of hardware, software, firmware and/or other computer components.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

Implementations of the current subject matter can provide one or more advantages. For example, the presently described subject matter provides the ability to identify and make use of relationships between the different items of learning content. The presently described subject matter provides for creation and/or augmentation of accurate information associated with learning content, facilitating the finding of relevant, appropriate learning content for learners. The presently described subject matter provides for taking the learner's characteristics into consideration. For example, the presently described subject matter can account for the learner's knowledge, skill, background, and other personal characteristics. The presently described subject matter allows for feedback from learners, domain experts, educators, authors, and evaluators and using the feedback to improve search algorithms and information supporting the search algorithms.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to a software solution architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is an illustration of a variation of some components which may be used to develop a software program, or system, to implement the presently described subject matter.

FIG. 2 is an illustration describing some variations of items of learning content referenced by, used by, or implemented in a software program, or system, implementing the presently described subject matter.

FIG. 3 is an illustration describing variations of a node data item of a software program, or system, implementing the presently described subject matter.

FIG. 4 is an illustration of a user of a software program, or system, implementing the presently described subject matter.

FIG. 5 is an illustration of some variations of a relationship data item in a software program, or system, implementing the presently described subject matter.

FIG. 6 is an illustration of some variations of implementing a tag in a software program, or system, implementing the presently described subject matter.

FIG. 7 is an illustration of some variations of a relationship graph (also referred to as a graph) as may be used in a software program, or system, implementing the presently described subject matter.

FIG. 8 is an illustration of a semantic network defined by a graph.

FIG. 9 is an illustration of a rank data item as it can be used in a software program, or system, implementing the presently described subject matter.

FIG. 10 is an illustration of some variations of a rating in a software program, or system, implementing the presently described subject matter.

FIG. 11 is a process flow diagram illustrating aspects of a method having one or more features consistent with implementations of the current subject matter;

FIG. 12 is an illustration of a system having one or more features consistent with implementations of the current subject matter.

FIG. 13 is a process flow diagram illustrating aspects of a method for tagging items of learning content, the method having one or more features consistent with implementations of the current subject matter;

FIG. 14 is an illustration of the process of sharing a graph having one or more features consistent with implementations of the current subject matter;

FIG. 15 is an illustration of the process of sharing and branching a graph, having one or more features consistent with implementations of the current subject matter;

FIG. 16 illustrates a method for controlling the version of graphs, having one or more features consistent with the presently described subject matter;

FIG. 17 is a process flow diagram illustrating aspects of a method for matching content learners with learning content, having one or more features consistent with implementations of the current subject matter.

FIG. 18 describes a method for valuing tags, in accordance with one or more features of the current subject matter;

FIG. 19 is an illustration describing a method for valuing user tags, in accordance with one or more features of the current subject matter;

FIG. 20 is a process flow diagram illustrating aspects of a method for matching content learners with learning content, having one or more features consistent with implementations of the current subject matter.

FIG. 21 is an illustration describing a method for weighting relationships between nodes, having one or more features consistent with implementations of the current subject matter;

FIG. 22 is an illustration of a method for recommending nodes; having one or more features consistent with implementations of the current subject matter; and,

### DETAILED DESCRIPTION

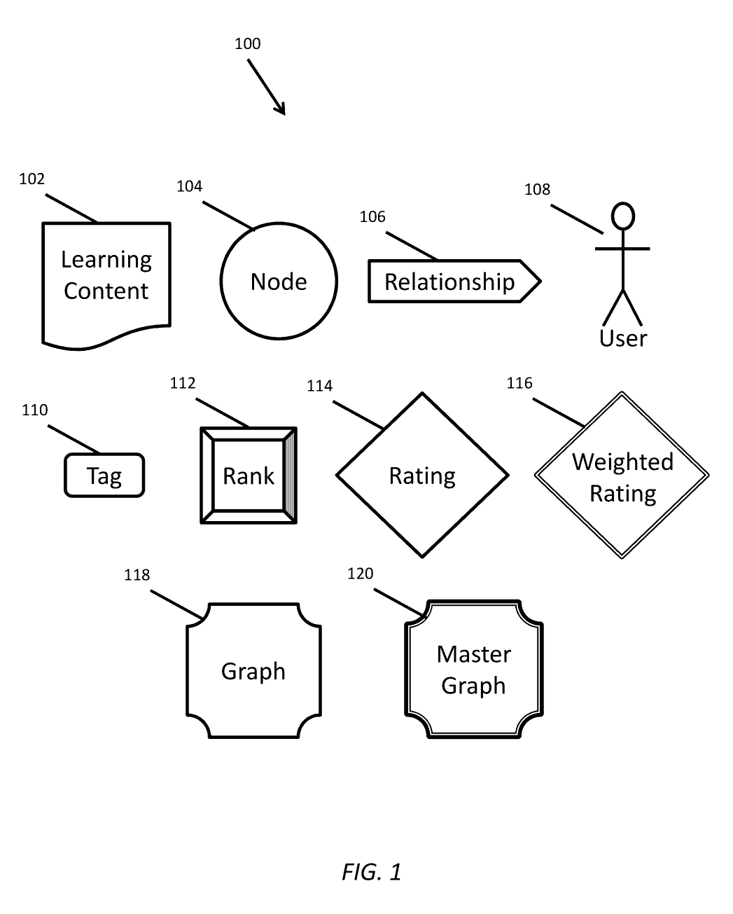

FIG. 1 is an illustration 100 of one or more components which are further described herein. The one or more components may be used to develop, or used in the operation of, a software program, system, or a method, implemented by one or more physical processors, to implement one or more elements of the presently described subject matter. In some variations, the components, taken as a subset or as a whole, include, but are not limited to: learning content (also equivalently referred to as “item(s) of learning content”) 102, node 104, relationship 106, user 108, tag 110, rank 112, rating 114, weighted rating 116, graph 118, and master graph 120. The software program, system, or process may include any number of each of the components. In some variations, the software program, system, or process may include a selection of the components. In some variations, the software program, system, or process may include other components. One of ordinary skill in the art will understand that the components illustrated in FIG. 1 are illustrative only and are not intended to be limiting. The components illustrated in FIG. 1 are included to facilitate describing the current subject only.

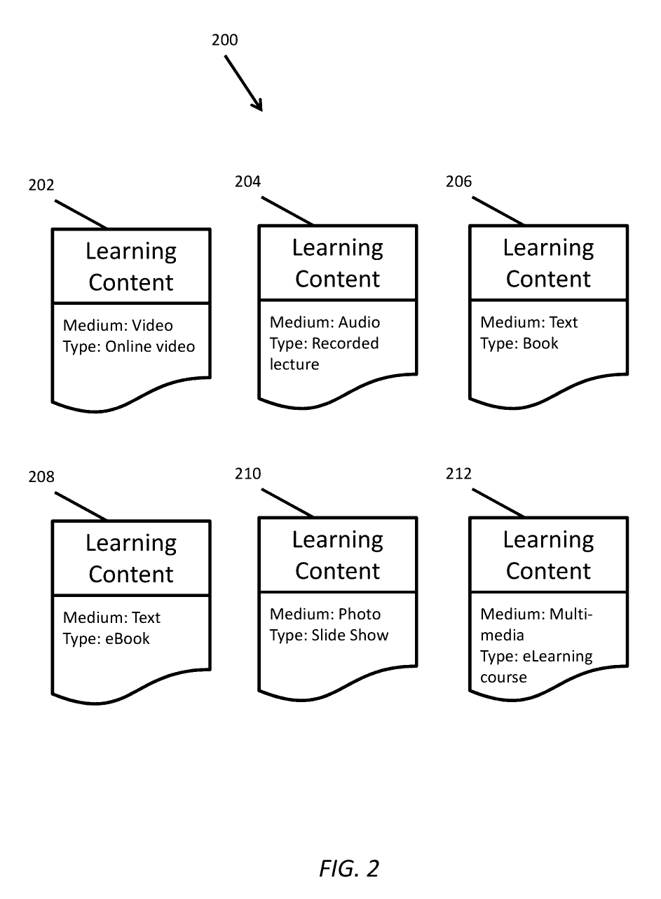

FIG. 2 is an illustration 200 describing some variations of items of learning content 202 referenced by, used by, or implemented in a software program, system, or method implemented by one or more physical processors, that implement one or more elements of the presently described subject matter. FIG. 2 is illustrative only to demonstrate possible variations of learning content medium and type and does not contain all possible learning content mediums or types. Items of learning content may be represented in any medium. Items of learning content can be represented, for example, in video, photographic, audio, text, multi-media, or other media. Further, these media may have subcategories. Learning content may include, but not be limited to online videos, e-books, e-learning courses, traditional courses, journal articles, textbooks, books, book chapters, speeches, e-learning lessons, blogs, forums, project definitions, homework, and other types of learning content. One of ordinary skill in the art would understand and appreciate that the presently described subject matter contemplates any form of learning content and the present subject matter is not limited to implementations involving the presently disclosed examples.

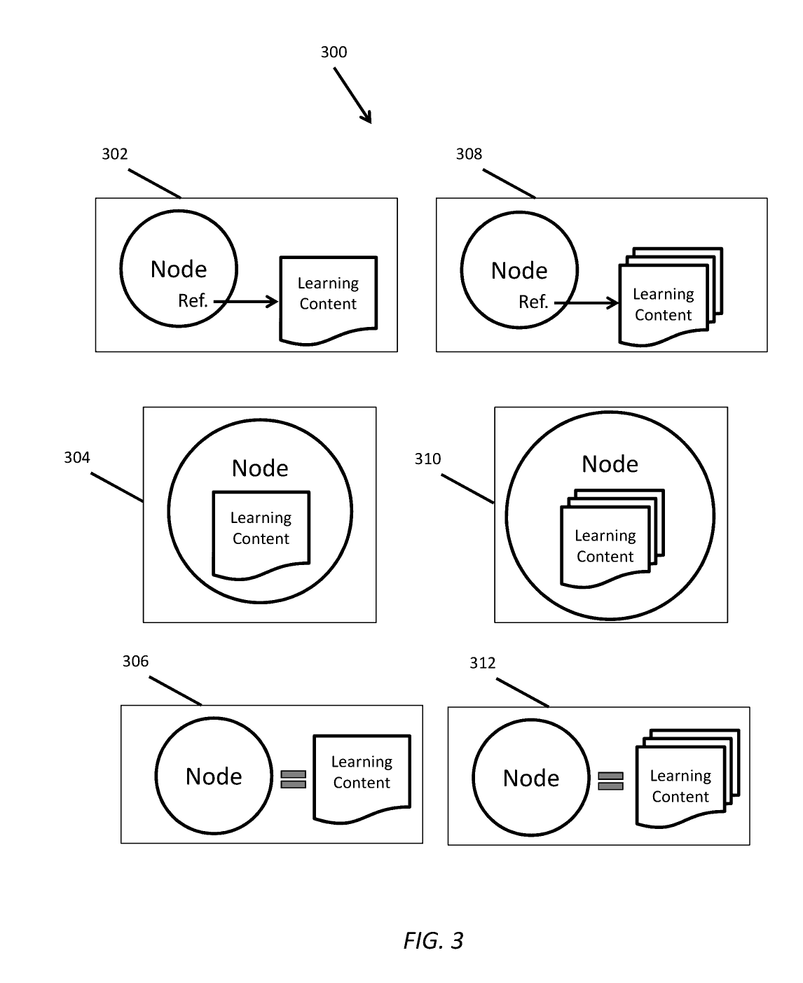

FIG. 3 is an illustration 300 describing variations of a node 104 data item of a software program, system, or a method implemented on one or more physical processors to implement one or more elements of the presently described subject matter. A node can be digital data that is one of: reference to an item of learning content 302, container for an item of learning content 304; item of learning content 306, reference(s) to item(s) of learning content 308, container for item(s) of learning content (310), and items of learning content. Some variations may also include nodes that contain many of references to, containers for, and/or instances of items of learning content. References to items of learning content may include, but not be limited to, a uniform resource identifier (URI), a uniform resource locator (URL), the name, title and/or author of the learning content, off-line location of learning content and/or other information associated with the learning content.

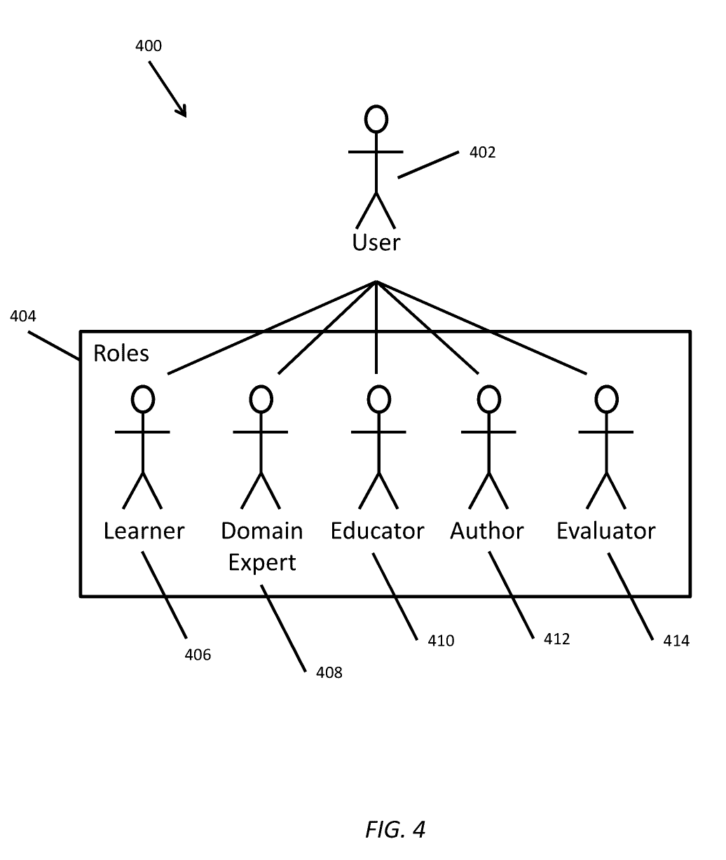

FIG. 4 is an illustration 400 of a user 108 of a software program, or system, implementing the presently described subject matter. A user is any person, group of persons, organization, software program, or system that interacts with a software program, or system, implementing the presently described subject matter. In some variations a user may also be a subsystem of a software program, or system, implementing the presently described subject matter.

Many different users and user types may use and interact with the presently described subject matter. FIG. 4 illustrates representative examples or user roles 404. One of ordinary skill in the art would appreciate and understand that the presently disclosed user roles and/or user types are not intended to be limiting and other user roles and/or types may also be implemented. A user can have any number of roles including but not limited to learner 406, domain expert 408, educator 410, author 412, and evaluator 414 and may act in one or more roles simultaneously or independently. A learner role can be acted by a user that consumes items of learning content. A domain expert role can be acted by a user that is familiar with subject matter contained within items of learning content, or is a teaching expert familiar with learning modes, learning development, learning pedagogies, and/or other aspects of teaching and/or learning. An educator role can be acted by a user that organizes, curates, recommends and delivers learning content. An author role can be acted by a user that organizes and produces learning content. An evaluator role can be acted by a user that evaluates learning content, users, and other aspects of the system implementing the presently described subject matter.

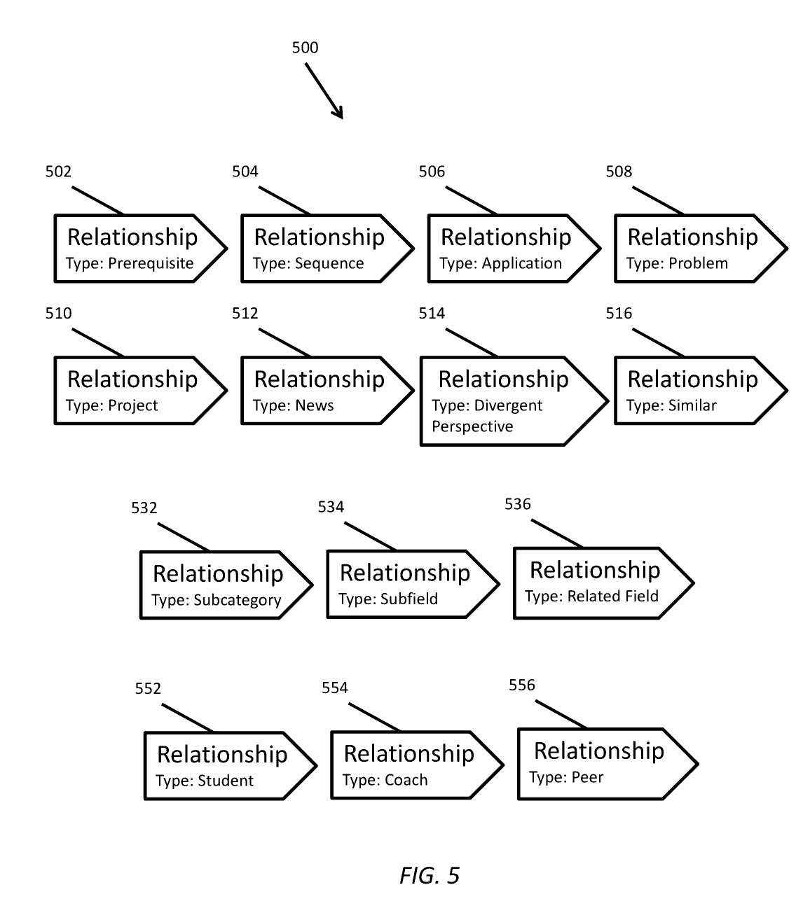

FIG. 5 is an illustration 500 of some variations of a relationship 106 data item in a software program, or system, implementing the presently described subject matter. The present disclosure contemplates any type of relationship between tags, nodes, items of learning content, users, and/or graphs. The relationships described herein are illustrative only and one of ordinary skill in the art would understand and appreciate that other relationships exist between tags, nodes, items of learning content, users, and graphs and that the presently disclosed subject matter is equally applicable to those relationships that are not described herein. Relationships can define directional or non-directional connections between tags, nodes, items of learning content, users, and/or graphs.

A relationship 502 may indicate that a first item of learning content should be learned prior to a second item of learning content. In some variations, any one of a number of different items of learning content may act as a pre-requisite for the second item of learning content. A learner may learn any one, or any plurality of ones, of the pre-requisite learning content before progressing onto the second item of learning content. Learning content that acts as a pre-requisite to other learning content can be from different sources of learning content and can include different types or media of learning content.

A relationship 506 may indicate that a second item of learning content is an application of a first item of learning content. A learner may learn a first item of learning content and then apply that learning content during their interaction with the second item of learning content. A relationship 516 may indicate that a first item of learning content is similar to a second item of learning content. A relationship 512 may indicate a second item of learning content includes news-type information related to the first item of learning content. A relationship 508 may indicate that a second item of learning content may be a sample problem of the first item of learning content. A relationship 514 may indicate a second item of learning content may include content of a divergent perspective from the first item of learning content. A relationship 504 may indicate a first item of learning content may have been included into the system prior to the second item of learning content. A relationship 510 may indicate a second item of learning content is a project or project definition relating to the first item of learning content. A relationship may indicate a second item of learning content is an example of the first item of learning content. A relationship may indicate a second item of learning content that poses questions to consider with respect to the first item of learning content.

A relationship 532 may indicate a second tag is a subcategory of a first tag. A relationship 534 may indicate a second tag is a subfield of first tag. A relationship 536 may indicate a second tag is a related field of a first tag. A relationship may indicate a second tag is part of a sequence relative to the first tag.

A relationship 552 may indicate a second user is a student of a first user. A relationship 554 may indicate a second user is a coach of a first user. A relationship 556 may indicate a second user is a peer of a first user. Relationships between users may also reflect any other relationships between persons including, but not limited to teacher, administrator, guide, classmate, parent, and mentor.

A node, item of learning content, tag, user and/or graph can include any number of relationships with any other number of nodes, items of learning content, tags, users and/or graphs. Nodes, items of learning content, tags, users and/or graphs may have many relationships between each other nodes, items of learning content, tags, users and/or graphs.

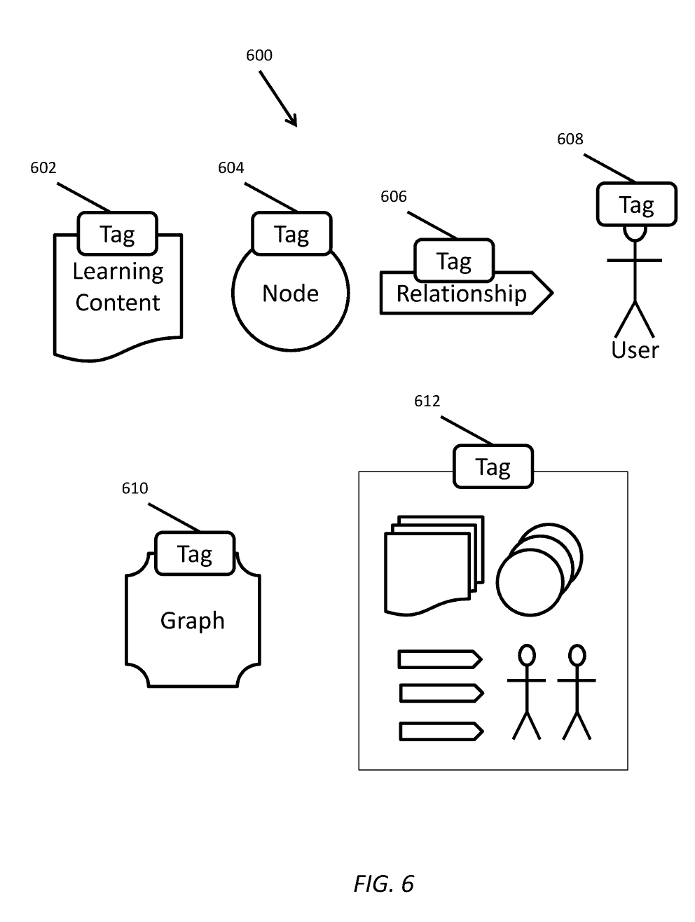

FIG. 6 is an illustration 600 of some variations of implementing a tag 110 in a software program, system, or method implemented using one or more physical processors, that implement one or more elements of the presently described subject matter. A tag 602 can characterize an item of learning content. A tag 604 can characterize a node. A tag 606 can characterize a relationship. A tag 608 can characterize a user. A tag 610 can characterize a graph. A tag 612 can simultaneously characterize any number of items of learning content, nodes, users, relationships and graphs.

A tag that simultaneously characterizes distinct components (i.e. items of learning content, nodes, users, relationships, graphs) may infer different meaning dependent on each component. For example, a “writing comprehension” tag associated with an item of learning content or node may characterize the item of learning content or node as containing learning content related to writing comprehension, while the same “writing comprehension” tag associated with a user may indicate the user has some capability of writing comprehension.

A tag characterizing a node may indirectly or directly characterize the item(s) of learning content associated with the node.

Tags can include descriptions or descriptors of one or more characteristics of subject matter, mode (for example visual learning, auditory learning, kinetic learning), quality, pedagogy, medium, complexity, difficulty, cost, type, or other characteristics of items of learning content, nodes, relationships, graphs and/or users. The tags can include key word descriptors reflecting the status or state of the characteristics of the item of learning content, nodes, relationships, graphs and/or users to which they relate. The tags can include numerical values providing an indication of a state of the characteristics of the item of learning content, node, relationship, graph and/or user to which they relate. An item of learning content, node, relationship, graph, and/or user can include a subject tag providing an indication of the subject of the item of learning content, node, relationship, graph, and/or user. For example, the subject tag may indicate that the learning content with which it is associated includes learning content on zoology. The item of learning content can have a difficulty tag associated with it. The difficulty tag may be a numerical value providing an indication of difficulty compared to learning content of the same or similar subject matter.

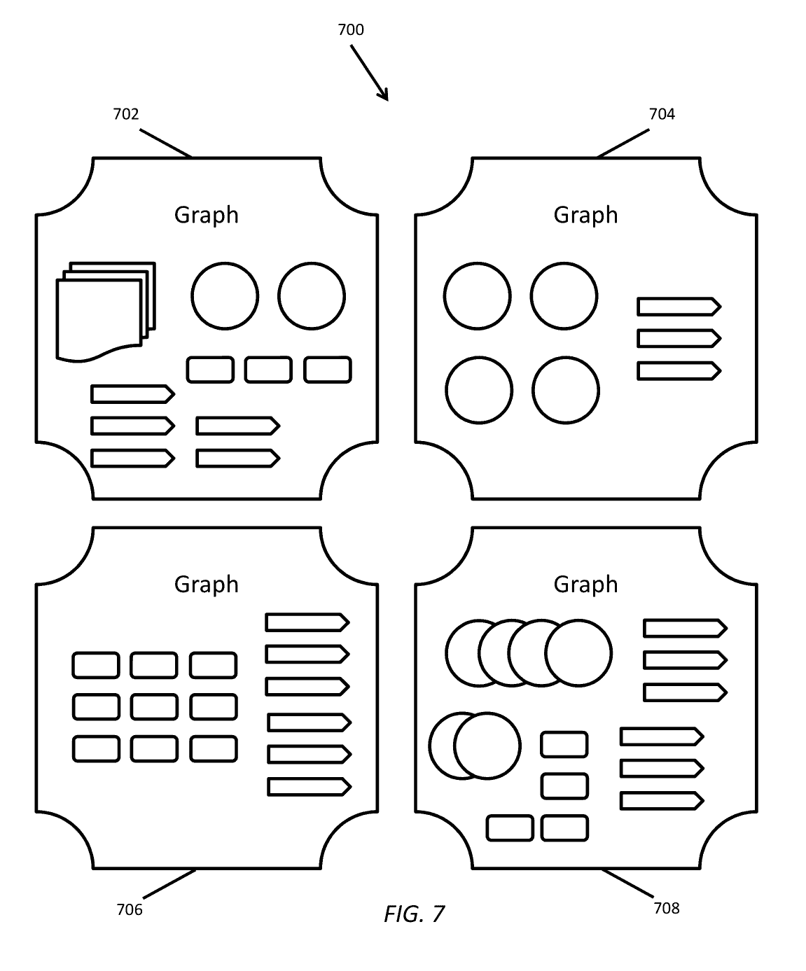

FIG. 7 is an illustration 700 of some variations of a relationship graph (also referred to as “graph”) 118 as may be used in a software program, or system, implementing the presently described subject matter. The graph can be generated with and/or include any subset of nodes, items of learning content, relationships, and tags associated with the system. FIG. 7 shows illustrative examples of graphs. A graph 702 can include any number of items of learning content, nodes, relationships and tags. In some variations, a graph 704 can include any number of nodes and relationships. In some variations, a graph 706 can include any number of tags and relationships. In some variations, a graph can include any number of nodes, tags, and relationships. In some variations, a graph can also include any number of users, ratings, weighted ratings, and ranks. In some variations, a graph can also include other components to support definition, characterization, rating, and delivery of the graph.

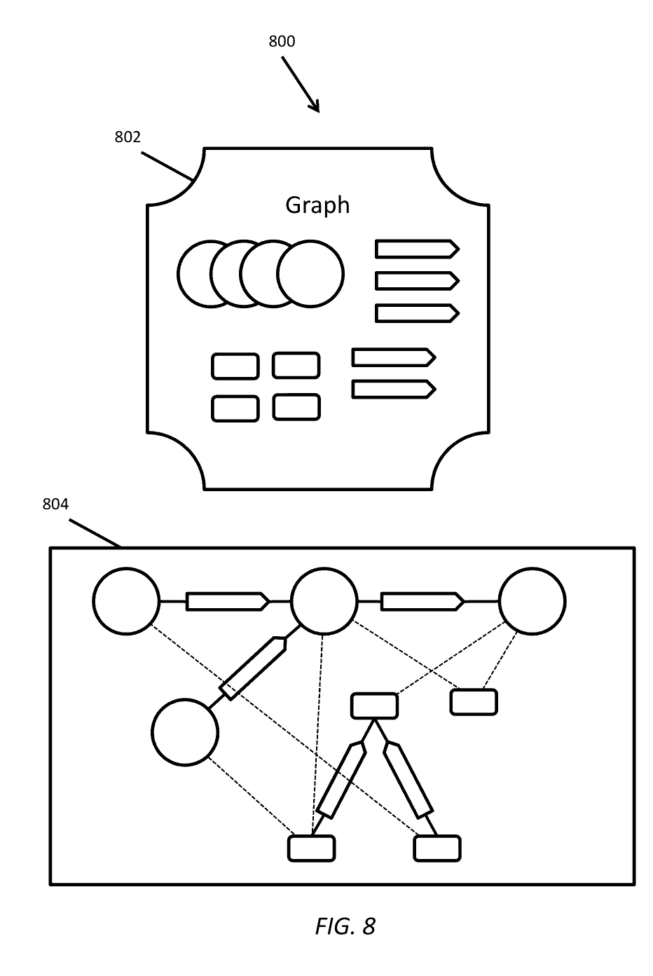

FIG. 8 is an illustration 800 of a semantic network defined by a graph. The semantic network is for illustrative purposes only to demonstrate connectivity between elements of a graph as could be implemented by a software program, or system, implementing the presently described subject matter. An example graph 802 is provided for illustrative purposes only and consists of 4 nodes, 4 tags, and 5 relationships. An example semantic network 804 is provided for illustrative purposes only and illustrates graph connectivity by connecting nodes with their respective relationships (solid lines), connecting tags by their respective relationships (solid lines), and connecting tags to nodes based on which tags are used to characterize nodes (dashed lines).

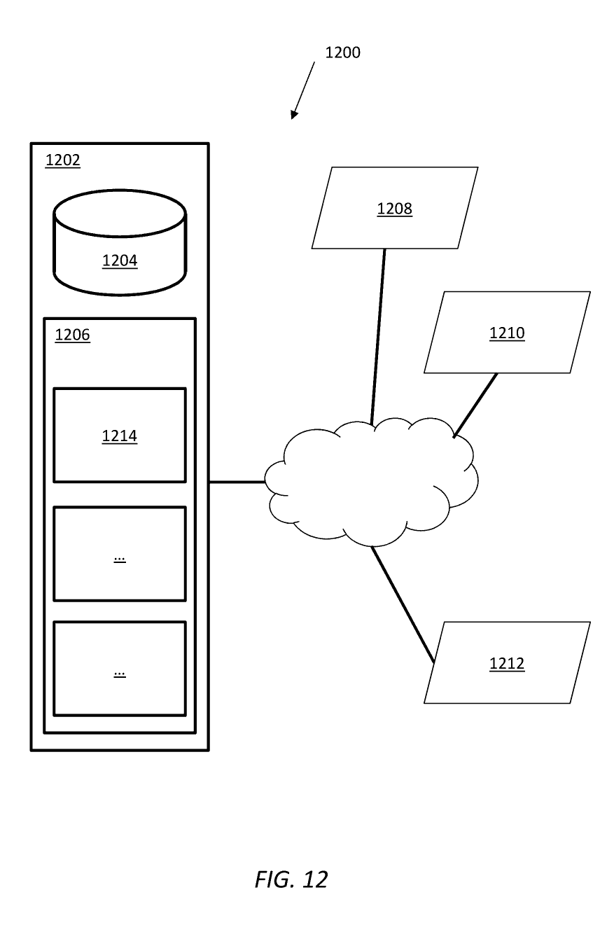

A master graph 120 may be provided that is a complete set of all nodes, relationships, and tags associated with the software program, system, or method implemented by one or more physical processors, that implement one or more elements of the presently described subject matter. Information used in the software program, system, or method can be stored in one or more database. The database(s) may be stored in non-transitory machine-readable media, such as electronic storage 1206 in FIG. 12. The master graph can enable uniqueness of nodes and relationships. For example, graphs only need to map their nodes and relationships to the master graph. One or more other graphs may be provided that are a subset of the master graph. One or more other graphs may augment the information in the master graph. In some variations the master graph may also include a complete set of any or all items of learning content, ratings, weighted ratings, users and/or other components associated with the software program or system implementing one or more elements of the presently described subject matter.

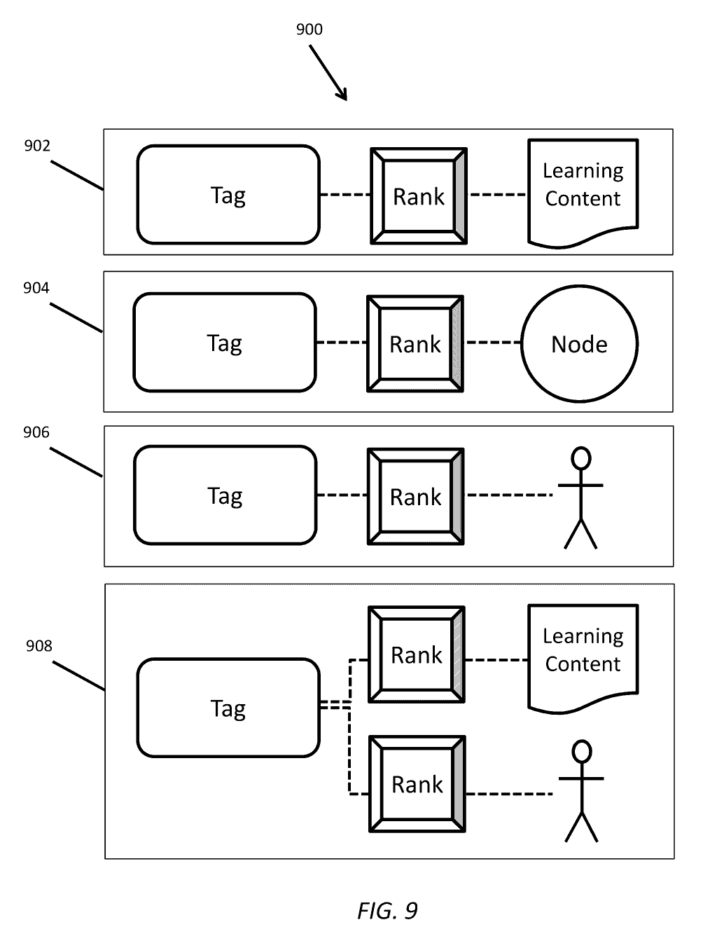

FIG. 9 is an illustration 900 of variations of implementing a rank 112 data item as it can be used in a software program, or system, implementing the presently described subject matter. A rank can be associated with a tag and may be used to quantify a tag. The rank(s) may be a numerical rank(s). A numerical rank can be based on any scale. An example of a numerical scale is a scale from 1 to 5, 1 to 10, 1 to 100, 0 to 1 or any other numerical scale. As illustrated by 902 and 904, a rank can be associated with a tag that is associated with an item of learning content or node, respectively. An example for a use of a rank is to provide an indication of the relative difficulty of the learning content. In such a case, a rank can describe the level of difficulty with respect to the node or item of learning content that the tag is characterizing. As illustrated by 906, a rank can be associated with a tag that is associated with a user. In such a case, a rank can describe the level of capability with respect to the user that the tag is characterizing. A rank can be associated with a tag that is associated with a graph. In such a case, a rank can describe the level of difficulty with respect to the graph that the tag is characterizing. As illustrated by 908, several ranks can be associated with a single tag this is associated with several other components. In such a case, for example, a rank may identify the difficulty of the learning content and the capability of the user with respect to the tag that can be associated to each learning content and user. In such a case, for example, ranks with similar values may indicate an learning content appropriately matched to a user with respect to the tag. Rank values may be calculated by the system as described further below.

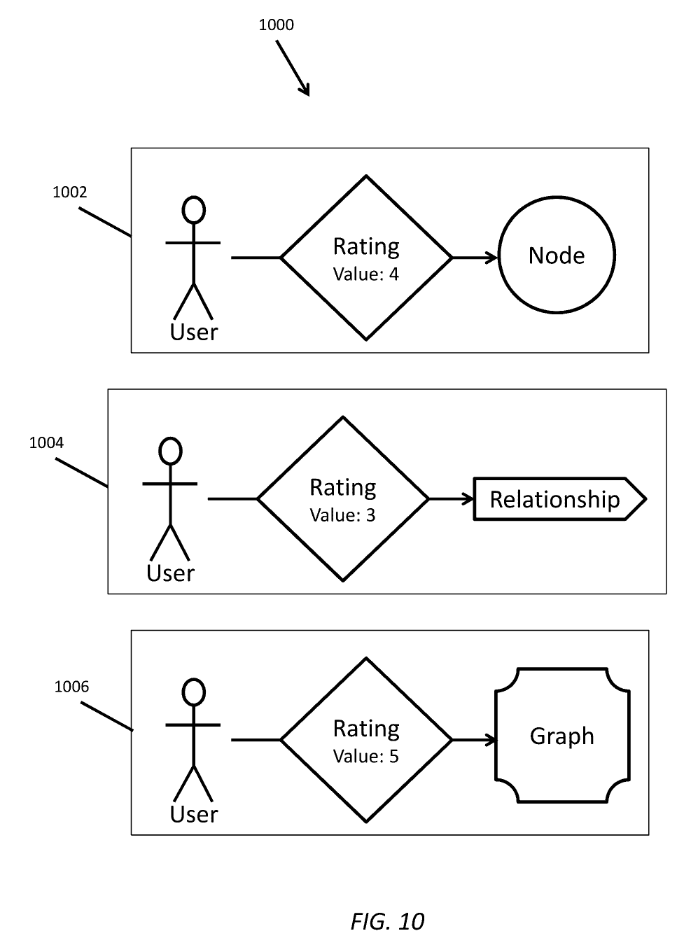

FIG. 10 is an illustration 1000 of some variations of a rating 114 in a software program, system, or method implemented using one or more physical processors, that implement one or more elements of the presently described subject matter. Each rating may be a numerical rating. The numerical rating can be based on any scale. An example of a numerical scale is a scale from 1 to 5, 1 to 10, 1 to 100, 0 to 1, or any other numerical scale. A rating may be applied to any of an item of learning content, node, relationship, tag, or graph. A rating for an item of learning content can be a measure of the quality of the item of learning content. A rating 1002 for a node can be a measure of the quality of the referenced or included learning content. A rating for a tag can be a measure of the appropriateness of the tag with respect to what the tag is characterizing. A rating 1004 for a relationship can be a measure of the appropriateness and/or quality of the relationship. A rating 1006 for a graph can be a measure of the quality of the graph.

A special type of rating is a weighted rating 116 in a software program, system, or method implemented using one or more physical processors, that implements one or more elements of the presently described subject matter. Each weighted rating can have the same properties and applicability as other ratings as described herein. A weighted rating can be automatically calculated based on a number of factors as described further below.

For all components in 100, including 102, 104, 106, 108, 110, 112, 114, 118, and 120 there can be information associated with each component. Each node in the system can have separate and distinct node information associated with it. Each tag in the system can have separate and distinct tag information associated with it. Each relationship in the system can have separate and distinct relationship information associated with it. Each graph in the system can have separate and distinct graph information associated with it. Each user in the system can have separate and distinct user information associated with it. Methods described below, each having one or more features consistent with implementation of the current subject matter, can reference, create, use, update, and append each system component's information. In some variations, each component in the system can have separate and distinct information associated with it, including but not limited to items of learning content, ratings, weighted ratings, ranks, and master graph.

Each of the entities described herein may be grouped into cohorts. For example, users, learning content, nodes, tags or graphs may be grouped into cohorts of users, learning content, nodes, tags, or graphs. The cohorts may include entities having similar characteristics, or characteristics within a range. The cohorts may have cohort-specific information associated with the cohorts.

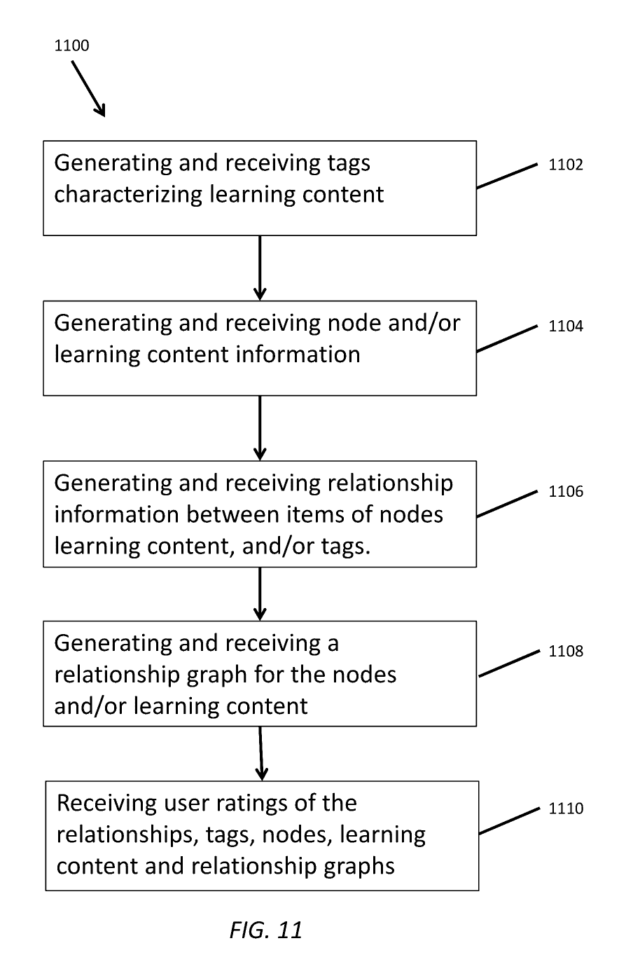

FIG. 11 is a process flow diagram 1100 illustrating aspects of a method having one or more features consistent with implementations of the current subject matter. The operations described in connection with the method illustrated by process flow diagram 1100 may be performed by one or more data processors, such as data processors 1206 illustrated in FIG. 12 and described below. The one or more data processors may form part of at least one computing device or system, such as computing system 1206. The method can provide relationships between learning content to facilitate providing that learning content to learners. The method can rate relationships, tags, nodes, learning content and graphs to facilitate providing optimized learning content to learners.

At 1102, a set of tags can be generated. The set of tags can characterize one or more nodes and/or items of learning content. In some variations, the tags may be associated directly with the item of learning content. In other variations, the tags may be associated with a node.

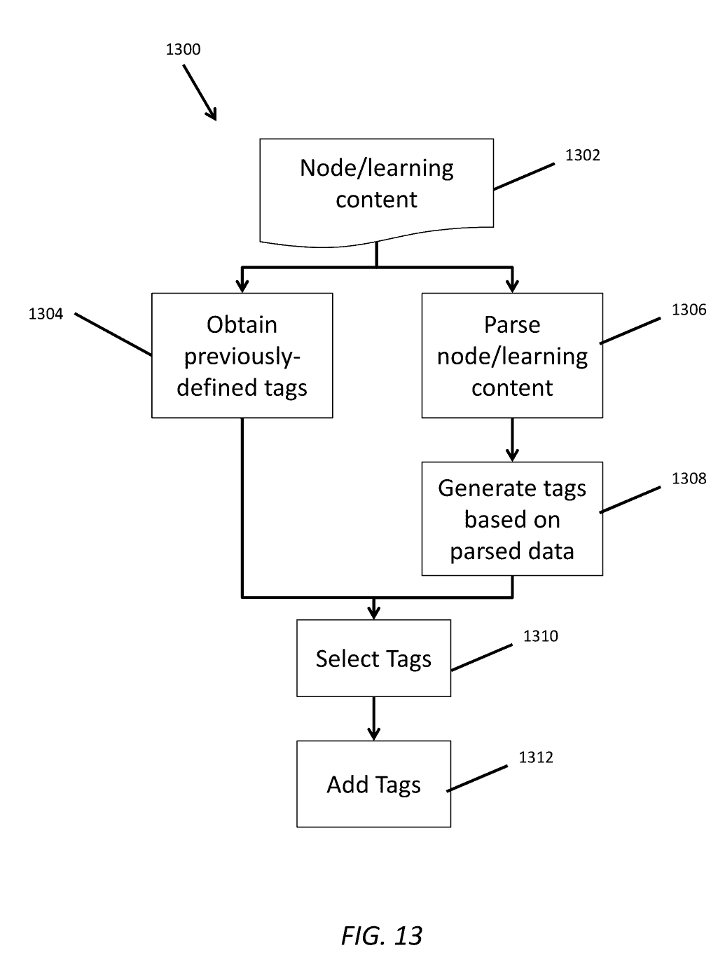

FIG. 13 is a process flow diagram 1300 illustrating aspects of a method for tagging nodes and/or items of learning content, the method having one or more features consistent with implementations of the current subject matter. At 1302, the node and/or item of learning content may be obtained. At 1304, previously-defined tags for the node and/or item of learning content can be obtained. At 1306, the node and/or item of learning content can be processed to determine the characteristics of the node and/or item of learning content. Such processing can include parsing the information contained in the node and/or item of learning content. The processing step may include, examining web page metadata, examining web page content, performing keyword searches on the content of the item of learning content, performing speech recognition on the item of learning content to determine key words, performing text recognition on the item of learning content to determine key words, analyzing content summaries, analyzing incoming and outgoing link paths of online learning content to infer content characteristics, and other processing operations. At 1308 tags may be generated based on the processing of the nodes and/or items of learning content.

In some variations, the obtained tags may be from a mix of previously-defined tags and tags generated from the processing of the nodes and/or items of learning content.

At 1310 tags may be selected by a user. The user may be presented with a list of tags from which to choose. Such lists may include a list of automatically-generated tags generated at 1308, a list of tags obtained at 1304, or other tags. At 1310 the user may select the tags which the user believes to accurately characterize the node and/or item of learning content. In some variations, at 1312 the user may define new tags. The tags selected and added by the user at 1310 and 1312 can be aggregated with any previously defined tags and saved in a database as part of the node information and/or item of learning content information. The tags selected and added by the user at 1310 and 1312 can be saved in a database as part of the user's information and identified as being referred to the node and/or item of learning content. Process 1300 may be used at any time to create, augment, delete, and/or modify any of the tags. The process 1300 is applicable to any user of the system when creating and/or augmenting the set of tags for the node and/or item of learning content.

At 1104, one or more sets of node and/or learning content information can be generated and received. Node and/or learning content information can be associated with the one or more nodes and/or items of learning content. The node and/or learning content information can include the set of tags that characterize the one or more nodes and/or items of learning content. Node and/or learning content information may be metadata that accompanies nodes and/or items of learning content. The user can add node and/or learning content information; for example, the user can add description, summary or comments text information. Node and/or learning content information may be entries in a database that reference the identity and location of the node and/or item of learning content.

At 1106, relationship information can be generated and received. Relationships may be provided by users (acting in any or multiple roles) of a software program, or system, implementing the presently described subject matter.

In some implementations, some users, such as users acting in the roles of domain experts, teachers, and/or evaluators, may review the relationships provided by other users and evaluate the appropriateness of the relationships. Some users may have the ability to evaluate the relationship information prior to the relationship information being used by the system.

Relationship information may be generated automatically. Information associated with the nodes and/or items of learning content may be parsed to determine key words included in the items of learning content. Metadata, titles, and existing information associated with the items of learning content may be used to determine relationships between various items of learning content. For example, a provider of learning content may have a list, database, metadata, course descriptions, or titles for their items of learning content that reveal relationships between them. Course titles, for example, may include “Practical Calculus 1” and “Practical Calculus 2.” The titles reveal both the subject matter, course order, and, likely, prerequisite relationship information between the two items of learning content. Learning content providers may have curriculums providing an order to items of learning content that they offer. The curriculums can provide relationship information among many items of learning content.

The relationship information herein described can be applied to relationships between tags. For example, multiple items of learning content may include the same tag. One such example would be that all learning content in the field of zoology would have a “zoology” tag. The “zoology” tag may itself have a relationship with a “biology” tag indicating that zoology is a subset of biology. In this manner a tag hierarchy may be created, where learners wishing to learn about zoology may first have to learn the basics of biology. This has an advantage over previous systems of finding learning content, because, for example, when a learner wishes to learn about zoology, they may be first taken to a foundational course in zoology, but this may be an item of learning content that far exceeds their current capabilities. The learner may first need a basic understanding of biology before tackling a foundational course in zoology.

The generated relationship information may be curated by users of a system implementing the presently described subject matter. In some variations, some users, such as those acting in the roles of domain experts, teachers, and/or evaluators, may modify, augment, and/or delete relationships between tags.

At 1108 a relationship graph (also referred to as graph) can be generated and/or received. Users may select any subset of nodes, items of learning content, relationships, and/or tags from the master graph to create a graph. Users may create a set of nodes, items of learning content, relationships, and/or tags independently of the master graph to create a graph and may add it to the master graph; in this case, if the graph is added to the master graph, the elements of the graph will be added to the master graph. Generating one or more graphs can facilitate management of the relationships, tags, and nodes. Generating one or more graphs can facilitate sharing and distribution of the graph(s). Generating one or more graphs can facilitate learning the items of learning content associated with the graph.

Bespoke relationship graph generation and augmentation may be offered to users. Such bespoke graphs and graph augmentation while appropriate for some users can be inappropriate for others causing other users of the system to have a sub-optimal experience. Providing users with bespoke relationship graphs and graph augmentation provide users with items of learning content that they otherwise may not have found or experienced. The generation of bespoke graphs and graph augmentation are generated based on relationship information that may be weighted by one or more factors. The master graph may include information associated with such weightings and may be used to facilitate the recommendation of items of learning content based on such weightings.

At 1110 ratings can be received from users. Ratings may be received through a graphical user interface. The graphical user interface may be presented through one or more user computing devices, such as client computing devices 1206, in FIG. 12. Ratings received from users can include ratings of tags, relationships, nodes, items of learning content, and/or graphs. Each rating provided by a user can be stored in a database as part of the user information. As part of the user information, each rating provided by a user will have a reference to the element being rated.

In response to receipt of the ratings, the tags, nodes, and/or relationships may be updated. In response to the tags being updated, learning content information associated with the items of learning content can be updated. In some variations, the ratings of the tags, nodes and/or relationships can translate into one or more weighted ratings for the tags, nodes and/or relationships. A weighted rating can be generated that is indicative of ratings received from all users. A weighed rating can be generated that is indicative of ratings from subsets of users, such as domain experts, teaching experts, and learners. Such subsets of users may be further divided, or divided differently based on other characteristics. Such other characteristics can include educational level, gender, geographic location, technology used to interact with the system, subject matter of interest, and other characteristics.

Relationship information may contain data to weight the quality and applicability of the relationship. Weighted ratings can be calculated for a relationship as a function of several variables to estimate the quality and applicability of the relationship.

Where nodes are present, the nodes may contain rating information, and weightings, for individual, or a group, of items of learning content.

Information in the graph can be updated. The graph can be updated by a provider of the graph. The graph can be updated by any user that is given update permission by a provider of the graph. The relationship graph can be updated in response to changes in the relationship information between items of learning content and/or in response to changes in the tags associated with the items of learning content. Where nodes are present, nodes may be updated based on changes to relationship information and/or tags, or may be updated directly.

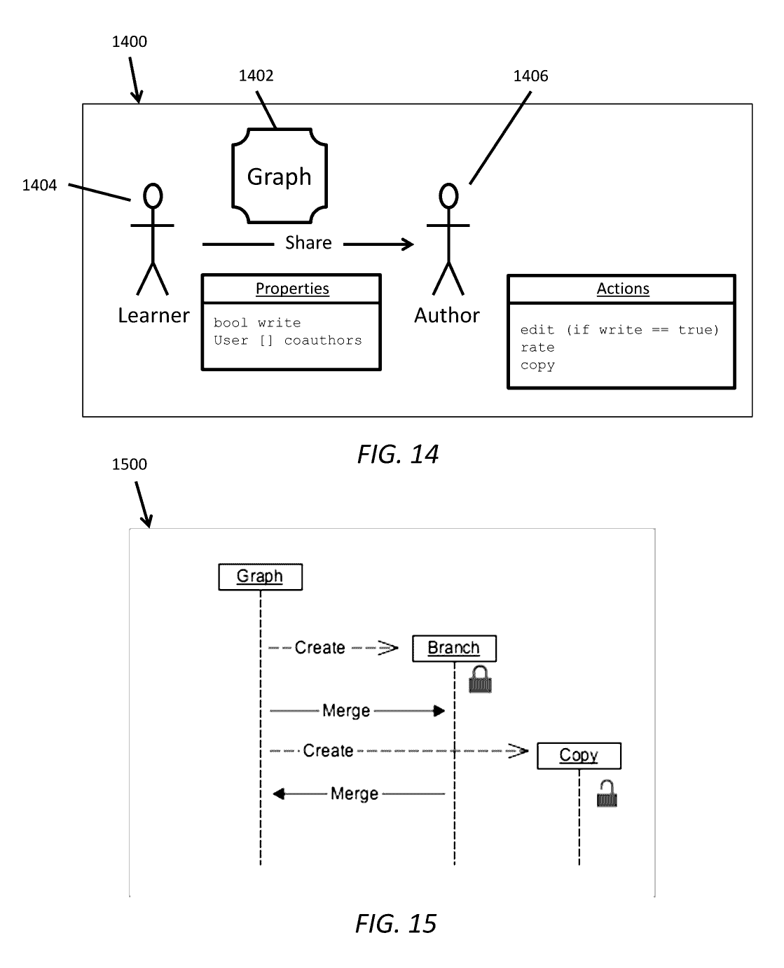

FIG. 14 is an illustration 1400 of the process of sharing a graph 1402 having one or more features consistent with implementations of the current subject matter. A graph 1402 can be shared by a first user 1404 with a second user 1406. The first user 1404 may be an author of the graph 1402 and/or the first user 1404 may have read or read-write privileges of the graph 1402. The graph 1402 may be a subset of the master graph. The second user 1406 may be a user, acting in any roles, of the graph 1402. The first user 1404 can define read privileges or read-write privileges to the other users that the user 1404 shares the graph with. Read privileges allow the other users to view the graph 1402. Read-write privileges allow other users to view and edit the graph 1402.

FIG. 15 is an illustration 1500 of the process of sharing and branching a graph 1402, having one or more features consistent with implementations of the current subject matter. A user may choose to copy a graph in which they have been granted read access. Copying a graph can create a distinct copy of the graph for which the user may modify, rate, characterize, and share. Copying a graph is distinct from branching a graph (described below) in that the graph copy is no longer connected to the original graph. A user may choose to branch a graph for which the user has been granted read access. Branching a graph creates a virtual copy of the graph for which the user may modify, rate, characterize, and share. Branching a graph allows the user to optionally merge changes made to the graph by the graph authors to the branch. In some variations, the original graph authors may grant access to the user to write to the graph. Changes made to the branched graph may cause changes to be made to the original graph.

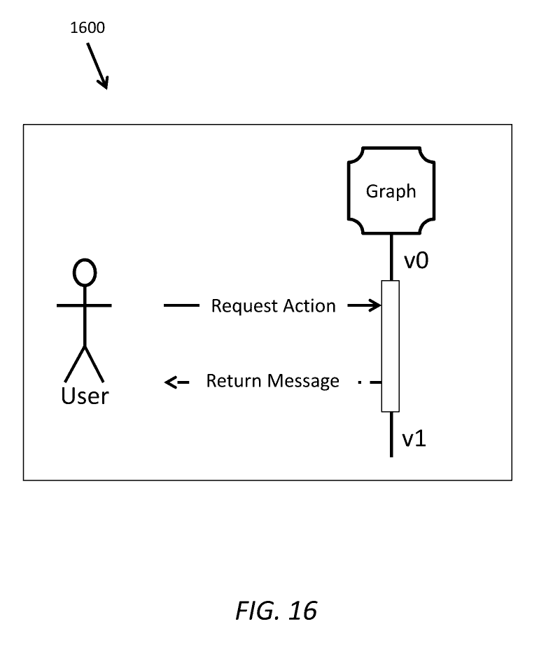

FIG. 16 illustrates a method 1600 for controlling the version of graphs, having one or more features consistent with the presently described subject matter. Each addition or removal of a tag, node or relationship to or from the graph, or any other update to or from the graph, can be recorded as a separate version. This can facilitate re-creation of, and/or reversion to, any version of the graph. Ratings, tags, and any other data associated with nodes, relationships, and/or items of learning content can be maintained in the master graph, regardless of the state of any one other graph.

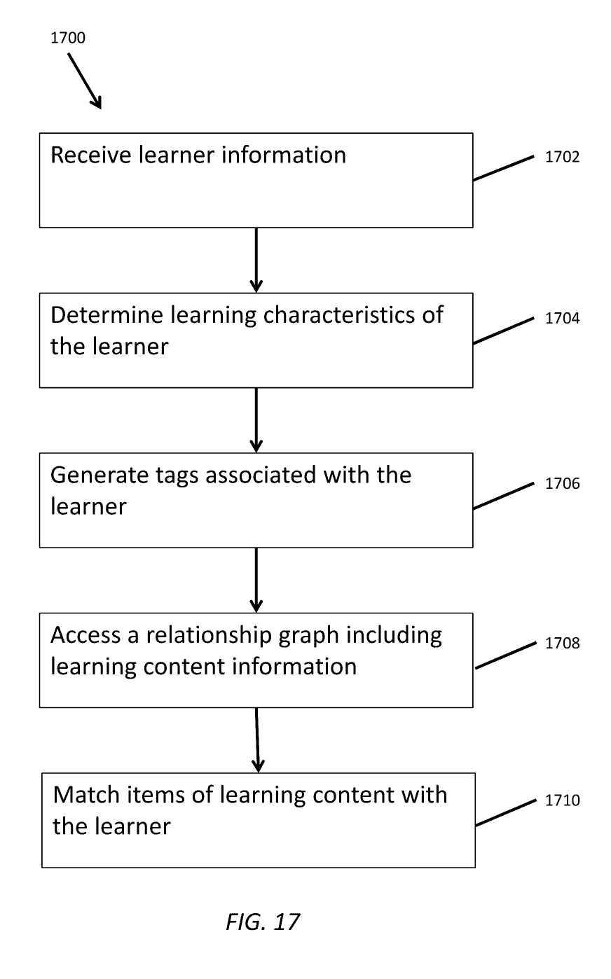

FIG. 17 is a process flow diagram 1700 illustrating aspects of a method for matching content learners with learning content, having one or more features consistent with implementations of the current subject matter. The operations described in connection with the method illustrated by process flow diagram 1700 may be performed by one or more data processors, such as data processors 1206 illustrated in FIG. 12 and described below. The one or more data processors may form part of at least one computing device or system, such as computing system 1200.

At 1702 receiving learner information can be received. The learner information can include one or more characteristics of a learner. The learning characteristics of the user can include one or more of experience, knowledge, skill, capability, preference of mode of delivery of learning content, a company learning scheme, a preferred cost structure, a preferred type of content for the learner, qualifications, current level of education, educational goals, or other learning and/or learner characteristics.

At 1704, one or more learning characteristics of the learner may be determined. This determination may be done automatically based on the one or more learning characteristics of the learner. One or more learning characteristics may be determined automatically by the learner's interaction with the system, including but not limited to: learner rating of nodes and/or items of learning content, learner rating of relationships, learner rating of graphs, evaluator evaluations of learner, and learner use of learning content and graphs.

At 1706, one or more learner tags can be associated with the determined learning characteristics of the learner and assigned to the learner. All tags associated with nodes, items of learning content, relationships, and graphs that the user interacts with can be automatically associated with a learner. Tag ranks can be automatically determined through statistical inference based on variables available to the system. Variables available to the system include all learner interactions with the system and all system information. Tags and their ranks associated with a learner can be a measure of the learner's capability with respect to the tag. Bespoke relationship graphs, graph augmentation, and learning content recommendations can use the automatically determined tag ranks to match the learner to learning content with similarly valued tag ranks.

A set of tags may be provided that define the mode of the learning content to which a learner relates to the most. Such tags may be referred to as “Mode Tags.” Modes in which a learner may be most responsive include visual learning, kinetic learning, auditory learning, project-based learning, reflective learning and other modes of learning. Similar to standard tags, Mode Tags can be automatically assigned to learners. Mode Tags enable the system, or software product, to refine the learning optimization process by including learning content mode and the user's preferred learning mode in the matching algorithm.

At 1708 a relationship graph defining relationships between one or more items of learning content may be accessed. The one or more items of learning content may have associated learning content tags characterizing the learning content. Examples of the formation of a relationship graph is described herein with respect to FIG. 11, however, the subject matter described herein is contemplative of working with any relationship graph.

At 1710, one or more items of learning content can be matched to the learner. The matching can be based on the one or more learner tags (with associated ranks), the one or more learning content tags (with associated tag ranks), and the relationships between the one or more items of learning content.

In some implementations, a curriculum can be generated for the learner. The curriculum can be based on the one or more learner tags, the one or more learning content tags, and the relationships between the one or more items of learning content. The curriculum can include a plurality of items of learning content.

In some variations a learner metric can be generated for the learner. The learner metric may be a function of the one or more learner tags generated from the learner characteristics. Learning content metrics can be generated for the one or more items of learning content. The learning content metric may be a function of the one or more learning content tags for the one or more items of learning content. The learner metric can reflect the learning characteristics of the user, including the subject of interest of the user, the knowledge of the user, the learning abilities of the user, the amount of time the user has to dedicate to learning, the goals of the user, and other learning characteristics of the user. The learning content metrics may reflect a subject of the learning content, a difficulty of the content, previous knowledge requirements, time commitment requirements and other learning content characteristics. The one or more items of learning content can be matched to the learner based on the learner metric being equal to or exceeding the learning content metric. In some variations, the metrics may include multiple values. In some circumstances only certain ones of the values of the user metric need exceed the corresponding values of the learning content metric. In other circumstances all of the values of the user metric need to exceed the corresponding values of the learning content metric.

In some variations at 1710, a request for learning content can be received from a learner. The relationship graph can be searched to identify one or more items of learning content matching the request for learning content from the learner. The relationship graph can be searched to identify one or more items of learning content that match with the learner's learning characteristics.

At least an indication of the learning content matching the learner's request can be output to the user. The indication may include a location of the content, a description of the content, characteristics of the content, and other information associated with the content.

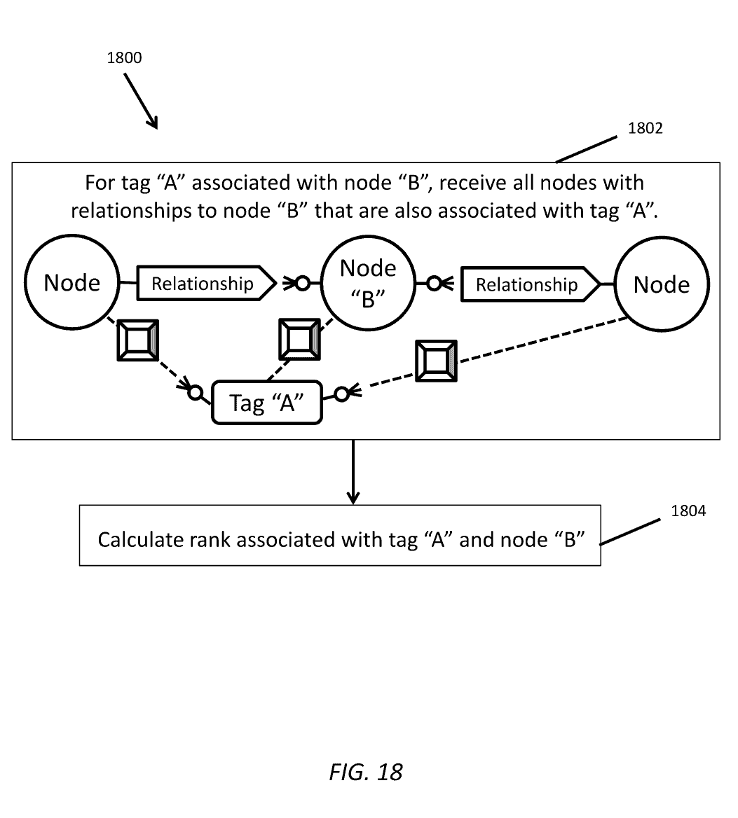

FIG. 18 describes a method 1800 for valuing tag ranks. The illustration in FIG. 18 includes the presence of nodes which contain information about their associated items of learning content. One of ordinary skill in the art would appreciate and understand that the operations of method 1800 as described herein can be performed to tags included in metadata that accompanies the items of learning content, tags directly associated with items of learning content, and/or other tags.

In 1802, for tag “A” associated with node “B”, the method can get all nodes with relationships to node “B” where the nodes are also associated with tag “A”. In 1804, node tag ranks can be calculated as a function of the nodes identified by 1802, users, users' node assessments, users' interactions with the system, user evaluations, and/or other data available within the system. Users' node assessments are users' subjective measures of how well users understand the learning content reference by the node (or the learning content associated with the node). User (e.g. assessor) evaluations can be users' subjective measures of how well other users understand the learning content referenced by the node. In the absence of any connectedness of node “B” to any other nodes associated with tag “A”, the rank of tag “A” with respect to node “B” can be set to the mean of users' ranks associated with tag “A”. In some implementations, the rank of tag “A” with respect to node “B” will be subtracted from based on the absence of other connections with node “B”.

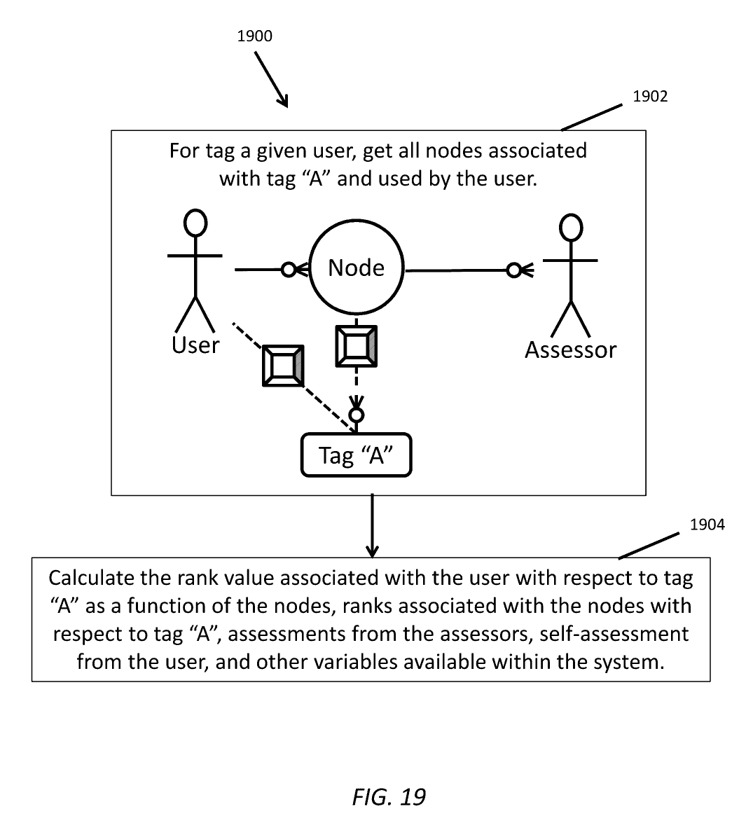

FIG. 19 is an illustration describing a method 1900 for valuing a rank associated with a tag associated with a user. In 1902, for tag “A”, the method can get all nodes used by the user. In 1902, all information associated with each node for the user (e.g. self-assessments, other users' (i.e. assessor's) assessments, etc. . . . ) can be obtained. In 1904, user tag ranks can be valued as a function of (at minimum) users' node assessments, user evaluations, and/or nodes and/or graphs used by and/or created by the user.

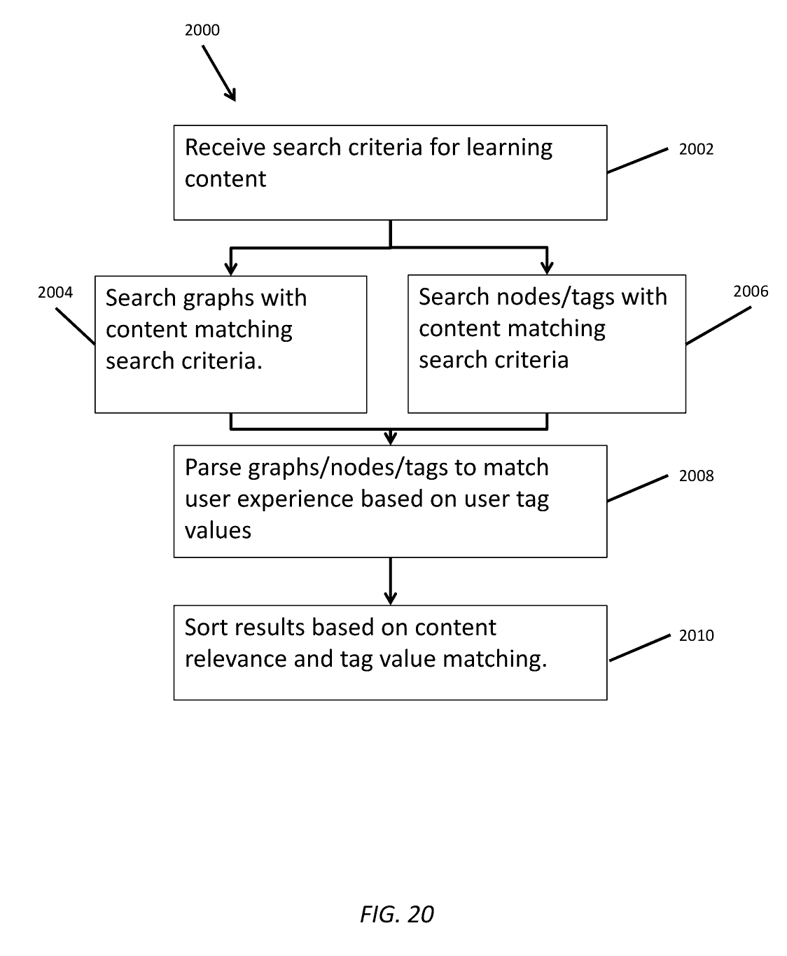

FIG. 20 is a process flow diagram 2000 illustrating aspects of a method for matching content learners with learning content, having one or more features consistent with implementations of the current subject matter. The operations described in connection with the method illustrated by process flow diagram 2000 may be performed by one or more data processors, such as data processors 1206 illustrated in FIG. 12 and described below. The one or more data processors may form part of at least one computing device or system, such as computing system 1200.

At 2002 search criteria can be received from a learner. The search criteria can include multiple variables relating to characteristics of learning content.

At 2004 graphs, to also include the master graph, may be searched to find learning content matching the search criteria. Similarly at 2006, nodes/tags associated with items of learning content may be searched to find learning content that matches the search criteria.

At 2008 records found from the operations at 2004 and 2006 may be parsed to match nodes and/or items of learning content with the user based on tags and tag ranks.

At 2010 the results of the operation at 2008 can be sorted by content, relevance, and/or tag rank matching.

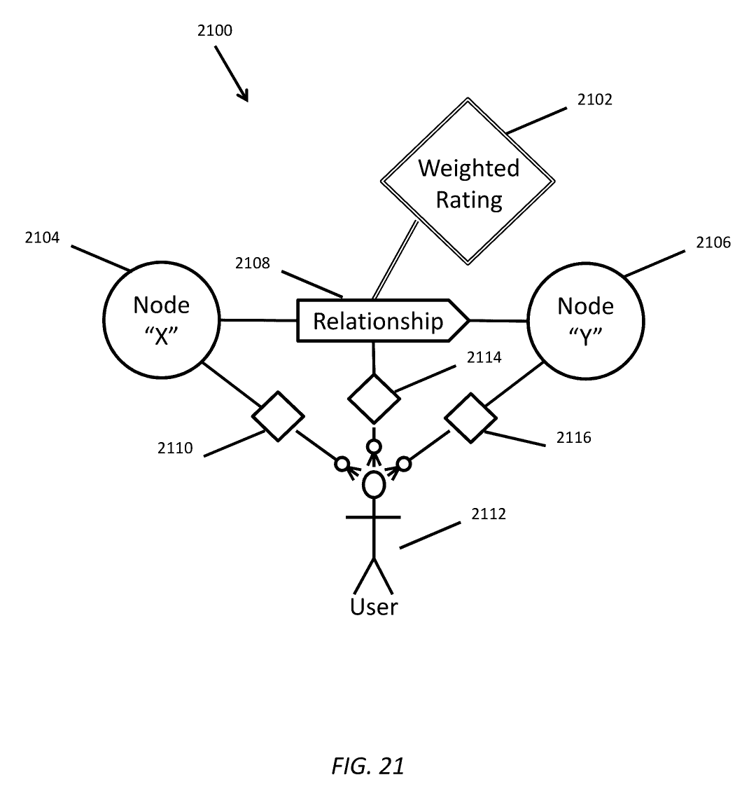

FIG. 21 is an illustration 2100 describing a method for calculating weighted ratings for relationships between nodes. The weighted rating 2102 can be any numerical value that quantitatively describes the efficacy of the relationship 2108 between node “X” 2104 and node “Y” 2106 An example of a numerical scale is a scale from 1 to 5, 1 to 10, 1 to 100, 0 to 1, or any other numerical scale. The weighted rating can be a function of (at minimum): users 2112 that have rated one or more relationships between node “X” and node “Y”; node “X”; node “Y”; relationship ratings 2114; node “X” ratings 2110 and node “Y” ratings 2116; tags, tag ranks, and/or users' node assessments. Weighted ratings may be stored as part of the relationship information and contained in the master graph stored. In some variations, the calculation of weighted ratings may be customized per user and stored as part of the user information. A weighted rating customized for a user can be used in the recommendation of learning content.

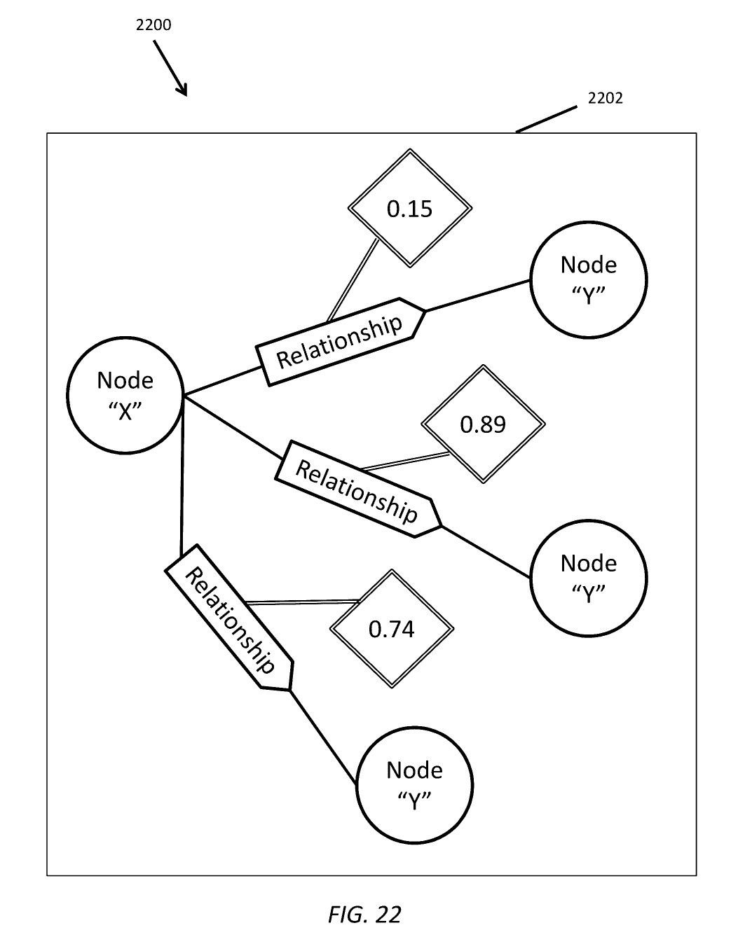

FIG. 22 is an illustration 2200 of a method for recommending nodes. Relationships with high weighted ratings connect the current node to nodes that will be recommended. Recommending nodes can further be refined by other factors such as mode tags and other characteristics of the learning content and/or the learner. In variations implementing a numerical value between zero and one for weighted ratings, the system may attempt to generate sequences of learning content recommendations where each connection has a weighted rating as close to one as possible. In this variation, the most optimally sequence of learning content will consist or weighted ratings with a product as close to one as possible. A product of weightings equal to one would be a maximally optimized learning content sequence.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

FIG. 12 is an illustration of a system 1200 having one or more features consistent with implementations of the current subject matter. The system 1200 may be configured to facilitate the matching of learning content to learners. The system 1200 may be configured to facilitate the matching of learning content to learners using one or more processes that have described herein. The system 1200 may include a server 1202.

The server 1202 may include electronic storage 1204, one or more processors 1206, and/or other components. The server 1202 may include communication lines, or ports to enable the exchange of information with a network and/or other computing platforms, such as client computing platforms 1208. Illustration of server 1202 in FIG. 12 is not intended to be limiting. The server 1202 may include a plurality of hardware, software, and/or firmware components operating together to provide the functionality attributed herein to server 1202. For example, server 1202 may be implemented by a cloud of computing platforms operating together as server 1202.

A given client computing platform 1208 may include one or more processors configured to execute computer program instructions 1214. The computer program instructions may be configured to enable an expert or user associated with the given client computing platform 1208 to interface with system 1200 and/or external resources 1210, secondary servers 1212 and/or provide other functionality attributed herein to client computing platforms 1208. By way of non-limiting example, the given client computing platform 1208 may include one or more of a desktop computer, a laptop computer, a handheld computer, a tablet computing platform, a NetBook, a Smartphone, a gaming console, and/or other computing platforms.

Client computing platform(s) 1208 can be configured to facilitate access to the relationship graphs stored on electronic storage 1204 by learners associated with the client computing platform(s). In some implementations, learners may search for learning content and may be matched to learning content, facilitated by server 1202. Information regarding the matched learning content may be provided to a learner through a graphical user interface associated with a client computing platform 1208 of the learner. The learner may enter and/or select learning content to interact with from the matched learning content. In some implementations, the server 1202 can be configured to provide the learning content to the learner through their client computing platform 1208. In other implementations, the server 1202 may cause the entered and/or selected learning content to be presented to the learner through their client computing platform 1208 from one or more external sources 1210 and/or secondary servers 1212, configured to provide learning content. In further implementations, the information about the matched learning content may include a location of the learning content. The client computing platform 1208 may be configured to obtain the learning content directly from its source in response to an entry and/or selection of the learning content by a learner.

The external resources 1210 may include sources of information, hosts and/or providers of virtual environments outside of system 1200, external entities participating with system 1200, and/or other resources. In some implementations, some or all of the functionality attributed herein to external resources 1210 may be provided by resources included in system 1200.

Electronic storage 1204 may comprise electronic storage media that electronically stores information. The electronic storage media of electronic storage 1204 may include one or both of system storage that is provided integrally (i.e., substantially non-removable) with server xx and/or removable storage that is removably connectable to server 1202 via, for example, a port (e.g., a USB port, a firewire port, etc.) or a drive (e.g., a disk drive, etc.). Electronic storage xx may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage xx may include one or more virtual storage resources (e.g., cloud storage, a virtual private network, and/or other virtual storage resources). Electronic storage xx may store software algorithms, information determined by processor 1206, information received from server 1202, information received from client computing platforms 1208, and/or other information that enables server 1202 to function as described herein.

Processor(s) 1206 is configured to provide information processing capabilities in server 1202. As such, processor 1206 may include one or more of a digital processor, an analog processor, and a digital circuit designed to process information, an analog circuit designed to process information, a state machine, and/or other mechanisms for electronically processing information. Although processor 1206 is shown in FIG. 12 as a single entity, this is for illustrative purposes only. In some implementations, processor 1206 may include a plurality of processing units. These processing units may be physically located within the same device, or processor 1206 may represent processing functionality of a plurality of devices operating in coordination. The processor 1206 may be configured to execute computer program instructions. The computer program instructions may cause the processor 1206 to perform one or more of the operations and/or features illustrated in FIGS. 1-22, and/or described herein. Processor 1206 can be configured to execute one more additional and/or alternative operations than those illustrated and/or described herein. Processor 1206 can be configured to perform its functions by software; hardware; firmware; some combination of software, hardware, and/or firmware; and/or other mechanisms for configuring processing capabilities on processor 1206.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for implementation by one or more data processors forming part of at least one computing device to provide relationships between learning content, the method comprising:
receiving, at the one or more data processors, indications of one or more items of learning content;
generating, using the one or more data processors, one or more sets of learning content information to associate with the one or more items of learning content;
receiving, using the one or more data processors, relationship information between individual ones of the one or more items of learning content from one or more users; and,
generating, using the one or more data processors, a relationship graph that includes the relationship information between individual ones of the one or more items of learning content.

2. The method as in claim 1, further comprising:
storing, using the one or more data processors, the relationship graph in a database in non-transitory machine readable media.

3. The method as in claim 1, wherein learning content includes one or more of video, photographic, audio, text, digital, or multi-media learning content.

4. The method as in claim 1, wherein relationship information defines connections between individual ones of the one or more items of learning content.

5. The method as in claim 1, further comprising:
facilitating, through a graphical user interface, users providing a rating of the relationship information between individual ones of the one or more items of learning content; and,
updating, using the one or more data processors, the one or more sets of learning content information, based on the rating.

6. The method as in claim 5, further comprising:
generating, using the one or more data processors, one or more relationship graphs for individual ones of the users, wherein generating the one or more relationship graphs for individual ones of the users comprises:
selecting, using the one or more data processors, one or more items of learning content to include in the one or more relationship graphs for the individual users based on the rating received from the individual users.

7. The method as in claim 1, wherein the learning content information is generated based on input received from one or more users associated with a subject matter of the one or more items of learning content.

8. The method as in claim 1, wherein the learning content information reflects one or more of a subject matter, a mode of delivery, a quality, a difficulty, a cost or a type of learning content of the one or more items of learning content.

9. The method as in claim 1, further comprising:
facilitating, through a graphical user interface, users to provide a graph rating of the relationship graph; and,
updating, using the one or more data processors, the relationship graph based on the graph rating.

10. The method as in claim 9, further comprising:
generating, using the one or more data processors, relationship information between one or more items of learning content information.

11. The method as in claim 1, wherein generating one or more sets of learning content information includes:
parsing, using the one or more data processors, the one or more items of learning content to generate estimated characteristics of each of the one or more items of learning content;
generating, using the one or more data processors, the one or more sets of learning content information that reflect the estimated characteristics for the one or more items of learning content.

12. The method as in claim 1, further comprising:
generating, using the one or more data processors, at least one learning metric associated with individual ones of the one or more items of learning content, the at least one learning metric based on the one or more sets of learning content information.

13. The method as in claim 1, wherein the one or more sets of learning content information include tags reflecting the characteristics of the one or more items of learning content associated with the one or more sets of learning content information.

14. A method for implementation by one or more data processors forming part of at least one computing device to match content learners with learning content, the method comprising:
receiving, by the one or more data processors, learner information, the learner information including one or more characteristics of a learner;
accessing, by the one or more data processors, a relationship graph defining relationships between one or more items of learning content, the one or more items of learning content having associated learning content information characterizing the learning content;
matching, by the one or more data processors, one or more items of learning content to the learner, the matching based on the one or more characteristics of the learner, the learning content information, and the relationships between the one or more items of learning content.

15. The method as in claim 14, wherein determining one or more learning characteristics includes statistically inferring the learning characteristics of the learner.

16. The method as in claim 14, wherein determining one or more learning characteristics includes receiving assessment information of the capabilities of the learner from one or more of the learner, and an assessor of the learner.

17. The method as in claim 14, further comprising:
generating, by the one or more data processors, a learner metric associated with the learner, the learner metric based on the one or more characteristics of the learner;
generating, by the one or more data processors, at least one learning content metric associated with the one or more items of learning content, the at least one learning content metric based on the learning content information associated with the one or more items of learning content.

18. The method as in claim 17, wherein the learner metric is assigned to at least one tag associated with the learner and the learning content metric is associated with at least one tag associated with the at least one learning content.

19. The method as in claim 14, further comprising:
generating, by the one or more data processors, a curriculum for the learner based on the one or more characteristics of the learner, the learning content information associated with the one or more items of learning content, and the relationships between the one or more items of learning content, the curriculum including a plurality of items of learning content.

20. The method as in claim 14, further comprising:
receiving, by the one or more data processors, a request for learning content from a learner;
searching, by the one or more data processors, the relationship graph to identify one or more items of learning content matching the request for learning content from the learner;
outputting, by the one or more data processors, at least an indication of the learning content matching the learner's request.
